(19) United States
(12) Patent Application Publication
(10) Pub. No.: US 2024/0208092 A1
(43) Pub. Date: Jun. 27, 2024

(54) MULTIPLE FUNCTION HAIR TRIMMER

(71) Applicant: CONAIR LLC, Stamford, CT (US)

(72) Inventor: Hon Hung Joseph CHAN

(73) Assignee: CONAIR LLC, Stamford, CT (US)

(21) Appl. No.: 18/069,599

(22) Filed: Dec. 21, 2022

(51) Int. Cl. B26B 19/06; B26B 19/38

(52) U.S. Cl. CPC B26B 19/06; B26B 19/3813

(57) ABSTRACT

There is provided a hair trimmer that has a body that houses a motor with the motor having a drive shaft that is rotatable and extends from the body, and at least three interchangeable attachments all driven by the drive shaft when each attachment is connected to the body. The at least three attachments include a linearly reciprocating hair trimmer blade assembly, a foil shaver head and a rotary nose trimmer blade assembly.

### BACKGROUND

### 1. Field of the Invention

The present disclosure is related to a hair trimmer. In particular, the present disclosure is related to a hair trimmer having multiple functions.

### 2. Description of Related Art

Motorized hair trimmers are available that groom facial hair such as beard and/or mustache hair. These motorized hair trimmers are limited in their functionality, and, thus, users are required to undesirably have multiple grooming appliances if they want, for example, trimming, nose trimming and/or shaving. Moreover, multiple appliances take up a lot of space and can require charging of multiple devices that takes a lot of time.

Accordingly, it has been determined by the present disclosure that there is a continuing need for a device that overcomes, alleviates, and/or mitigates one or more of the aforementioned and other deleterious effects of prior devices.

### SUMMARY

The present disclosure provides a hair trimmer that has a body that houses a motor with the motor having a drive shaft that is rotatable and extends from the body, and at least three interchangeable attachments all driven by the drive shaft when each attachment is connected to the body.

The present disclosure also provides that the at least three attachments include a linearly reciprocating hair trimmer blade assembly, a foil shaver head and a rotary nose trimmer blade assembly.

The above-described and other features and advantages of the present disclosure will be appreciated and understood by those skilled in the art from the following detailed description, drawings, and appended claims.

### DESCRIPTION OF THE DRAWINGS

FIG. 1 is a front view of a hair trimmer according to the present disclosure.

FIG. 2 is a rear view of FIG. 1.

FIG. 3 is a right side view of FIG. 1.

FIG. 4 is a left side view of FIG. 1.

FIG. 5 is a top view of FIG. 1.

FIG. 6 is a bottom view of FIG. 1.

FIG. 7 is a front view of the hair trimmer of FIG. 1 having a trimmer head disconnected from a body.

FIG. 8 is a rear view of FIG. 7.

FIG. 9 is a right side view of FIG. 7.

FIG. 10 is a side perspective view of the trimmer head of FIG. 7.

FIG. 11 is a top view of the body of FIG. 7.

FIG. 12 is a partial top view of a drive shaft and a slider of FIG. 7 having the drive shaft in a first position.

FIG. 13 is a partial top view of the drive shaft and the slider of FIG. 7 having the drive shaft in a second position.

FIG. 14 is a front view of the trimmer head of FIG. 7.

FIG. 15 is a front view of a T-blade trimmer head.

FIG. 16 is a front view of a foil shaver head.

FIG. 17 is a front view of a nose trimmer head.

### DETAILED DESCRIPTION

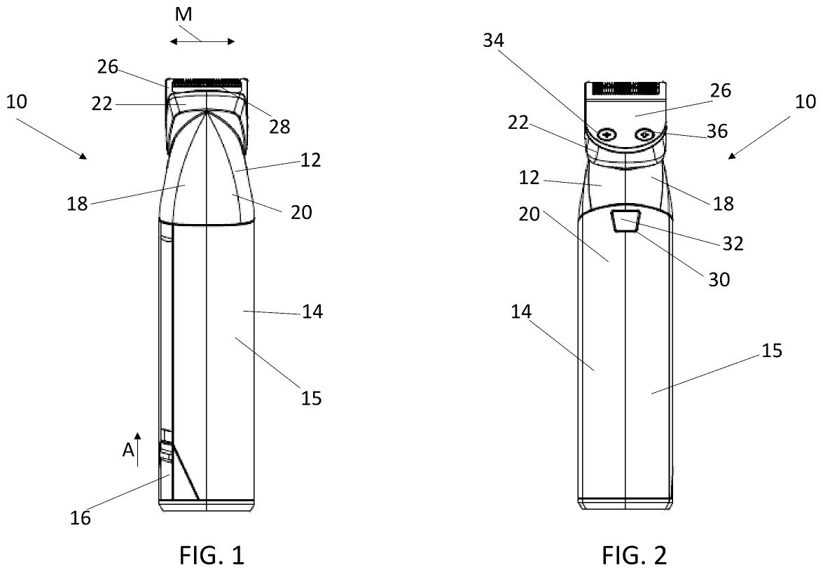

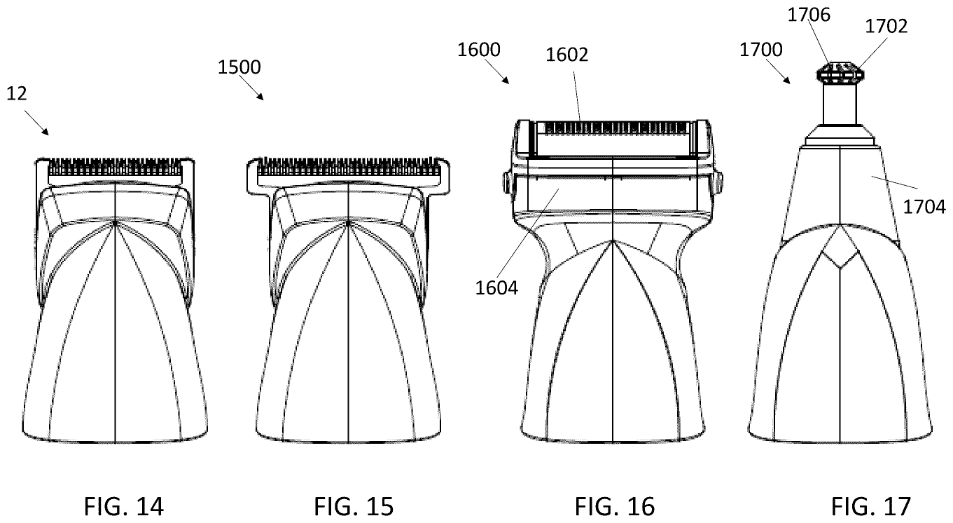

Referring to the drawings and in particular to FIG. 1, an exemplary embodiment of a hair trimmer according to the present disclosure is shown and is generally referred to by reference numeral 10. Advantageously, hair trimmer 10 has a body 14 that is removably connectable to at least three interchangeable attachments that include: 1) a reciprocating blade assembly as is typical in hair clippers and trimmers that includes of a trimmer head 12 as shown in FIG. 14 and/or a T-blade head 1500 as shown in FIG. 15, 2) a foil shaver head 1600 as shown in FIG. 16, and 3) a nose trimmer head 1700 as shown in FIG. 17.

Referring back to FIG. 1, hair trimmer 10 has trimmer head 12 that is removably connected to body 14. Body 10 forms a handle portion 15. Handle portion 15 has a sliding member 16, as shown in FIG. 6, that selectively slides in a direction A to activate a motor 17 (FIGS. 7-9) of hair trimmer 10 and a direction opposite direction A to deactivate the motor of hair trimmer 10. Trimmer head 12 has a housing 18. Housing 18 has a body connection portion 20 and a blade support portion 22. Body connection portion 20 is removably connectable to body 14. Blade support portion 22 is connected to a first blade 26.

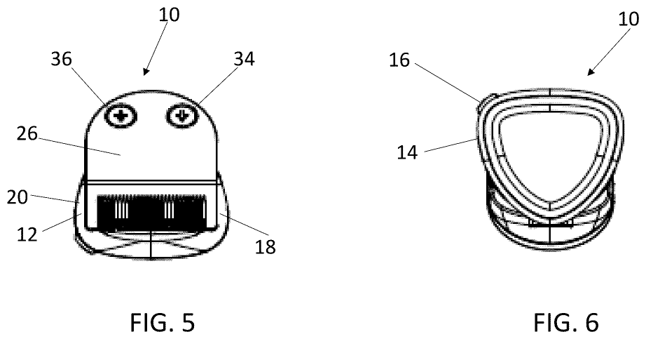

Referring to FIGS. 2 and 5, body 10 has an opening 30 and a button 32 that extends through opening 32. Blade support portion 22 is connected to first blade 26 by fasteners 34, 36, for example, screws, so that first blade 26 is in a fixed position on blade support portion 22.

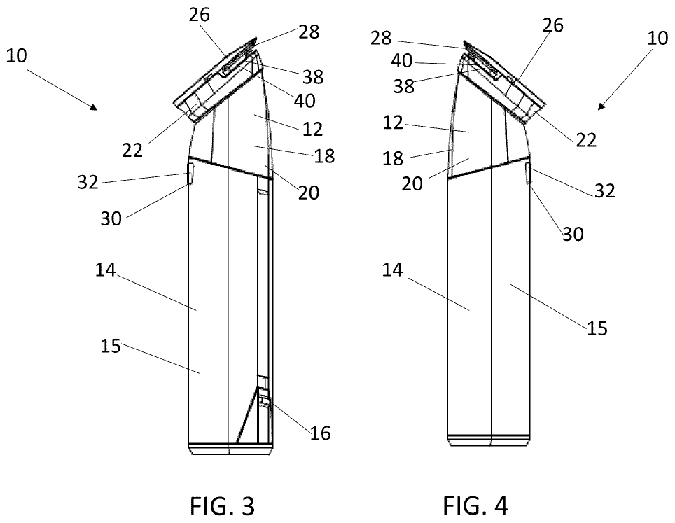

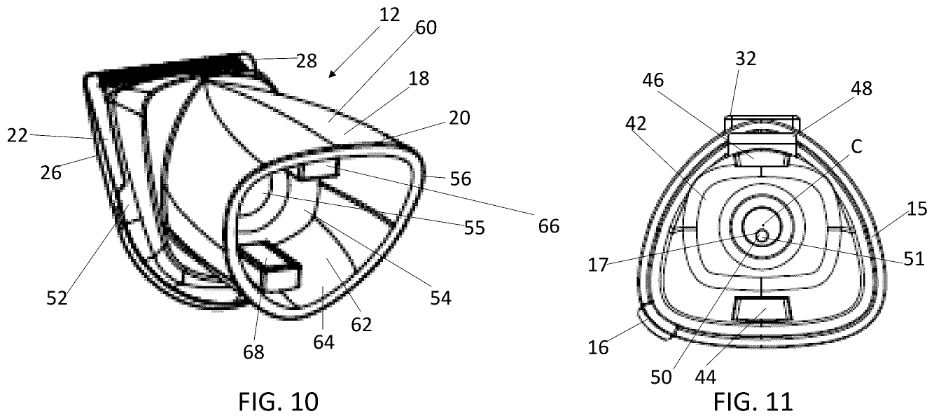

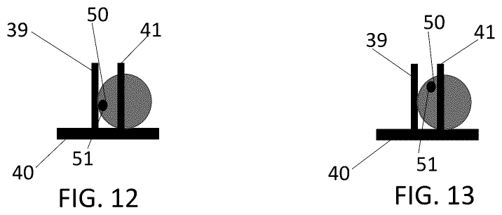

Referring to FIGS. 3 and 4, a protrusion 38 extends from a first side of a slider 40. Referring to FIGS. 12 and 13, two parallel walls 39, 41 can extend from a second side of slider 40 that is opposite the first side of slider 40 and extend through an opening 55 (FIG. 10) in blade support portion 22. Referring back to FIGS. 3 and 4, a second blade 28 is connected to protrusion 38 on the first side of slider 40 to be movable with slider 40.

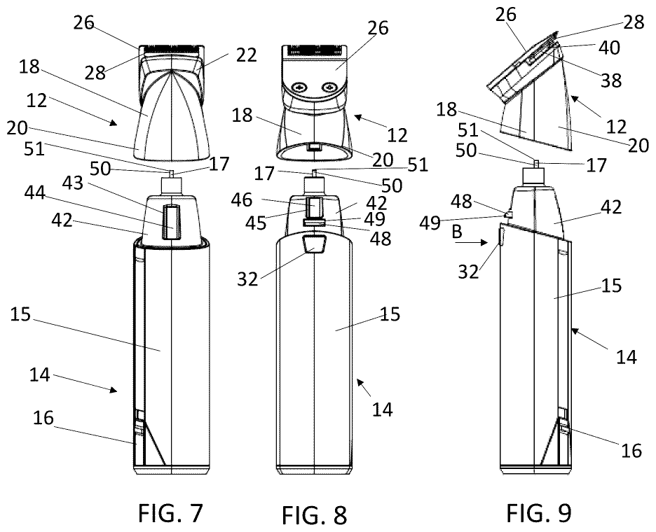

Referring to FIGS. 7-9, trimmer head 12 is selectively removable from body 14. Body 14 has a trimmer head connection portion 42 that extends from handle portion 15. Body 14 has a first slot 43, as shown in FIG. 7, and a second slot 45, as shown in FIG. 8, on opposite sides of trimmer head connection portion 42. A first magnet 44 is connected to trimmer head connection portion 42 in first slot 43, as shown in FIG. 7, and a second magnet 46 is connected to trimmer head connection portion 42 in second slot 45, as shown in FIG. 8. Body 14 has a spring latch 48. Spring latch 48 has a protuberance 49. Spring latch 48 is connected to button 32 so that when button 32 is pressed, then protuberance 49 of spring latch 48 is retracted in a direction B, as shown in FIG. 9, so that a portion of protuberance 49 of spring latch 48 is retracted inward inside of body 14 and when button 32 is released, then protuberance 49 of spring latch 48 returns to the extended position as shown in FIG. 9 by a force applied to protuberance 49 by a spring (not shown) of spring latch 48. Handle portion 15 houses a portion of motor 17 of hair trimmer 10 so that a drive shaft 50 extends from handle portion 15. Motor 17 is connected to a power source, for example, a rechargeable lithium-ion battery, housed in handle portion 15. Handle portion 15 can also house a controller, for example, a microcontroller unit and printed circuit board that controls operation of hair trimmer 10 so that sliding member 16 activates and deactivates motor 17. Motor 17 rotates drive shaft 50. Referring to FIG. 11, drive shaft 50 has an extension 51 that is off center from an axis of rotation C so that extension 51 moves in a circular path around axis of rotation C.

Referring to FIG. 10, blade support portion 22 has an exterior surface 52 that is opposite an interior surface 54. Exterior surface 52 connects to first blade 26. An opening 55 is formed through exterior surface 52 and interior surface 54. Body connection portion 20 of housing 18 of trimmer head 12 has an outer wall 56 that extends from blade support portion 22 and surrounds interior surface 54. Outer wall 56 has an outer surface 60 opposite an inner surface 62. Inner surface 62 of outer wall 56 and interior surface 54 of blade support portion 22 form an interior volume 64. A third magnet 66 is connected to inner surface 62 to protrude from outer wall 56 into interior volume 64 and a fourth magnet 68 is connected to inner surface 62 to protrude from outer wall 56 into interior volume 64. Third magnet 66 is positioned on outer wall 56 to be aligned with first magnet 44 of body 14. Fourth magnet 68 is positioned on outer wall 56 to be aligned with second magnet 46 of body 14. Inner surface 62 of outer wall 56 has a groove (not shown) that is complementary in shape to protuberance 49 of spring latch 48.

Referring back to FIGS. 7-9, to operate hair trimmer 10, trimmer head 12 is connected to body 14 by positioning body connection portion 20 of trimmer head 12 over trimmer head connection portion 42 of body 14 so that third magnet 66 is aligned with first magnet 44 and fourth magnet 68 is aligned with second magnet 46. As body connection portion 20 of trimmer head 12 slides over trimmer head connection portion 42 of body 14, body connection portion 20 of trimmer head 12 urges protuberance 49 of spring latch 48 in direction B so that a portion of protuberance 49 of spring latch 48 is retracted inward inside of body 14 allowing body connection portion 20 of trimmer head 12 to be placed over trimmer head connection portion 42 of body 14 so that protuberance 49 of spring latch 48 is aligned with the groove (not shown) in inner surface 62 of outer wall 56 allowing protuberance 49 of spring latch 48 to extend into the groove (not shown) in inner surface 62 of outer wall 56 connecting trimmer head 12 and body 14. In addition, first magnet 44 attracts third magnet 66 and second magnet 46 attracts fourth magnet 68 to connect trimmer head 12 and body 14. When trimmer head 12 is connected to body 14, drive shaft 50 of motor 17 extends through opening 55 of blade support portion 22 so that extension 51 engages slider 40, for example, two parallel walls 39, 41 that extend from the second side of slider 40. The user selectively moves sliding member 16 in the direction A to activate motor 17 rotating drive shaft 50 to turn hair trimmer 10 on. Rotation of drive shaft 50 by motor 17 moves extension 51 in a circular path around axis of rotation C that is translated into linear motion when extension 51 engages slider 40, for example, extension 51 moves in the circular path between two parallel walls 39, 41, as shown in FIGS. 12 and 13, that extend from the second side of slider 40 to alternately applying a force to each of two parallel walls 39, 41 to generate a reciprocating motion as shown by arrow M in FIG. 1 of second blade 28. The user can grip handle portion 15 of body 14 to use trimmer 10 to trim hair, for example, beard hair. The user selectively moves sliding member 16 in the direction that is opposite the direction A to deactivate motor 17 to turn hair trimmer 10 off.

Referring to FIGS. 14-17, hair trimmer 10 has body 14 that is removably connectable to at least three interchangeable attachments that include: 1) a reciprocating blade assembly as is typical in hair clippers and trimmers that includes of trimmer head 12 as shown in FIG. 14 and/or T-blade head 1500 as shown in FIG. 15, 2) foil shaver head 1600 as shown in FIG. 16, and 3) nose trimmer head 1700 as shown in FIG. 17. Trimmer head 12, T-blade head 1500, foil shaver head 1600, and nose trimmer head 1700 are all driven by the same drive shaft 50 extending from body 14. Trimmer head 12 and T-blade head 1500 are used for trimming facial hair, for example, beard hair. Foil shaver head 1600 is used for shaving facial hair, for example, mustache and beard hair. Nose trimmer assembly 1700 is used for trimming nose hair.

Trimmer head 12 and T-blade head 1500 are linearly reciprocating hair trimmer blade assemblies. T-blade head 1500 functions the same as trimmer head 12 except that T-blade head 1500 has different shaped blades. Accordingly, T-blade head 1500 connects to body 14 the same as trimmer head 12.

Foil shaver head 1600 is the same as trimmer head 12 except foil shaver head 1600 replaces first blade 26 and second blade 28 with a foil 1602 and a cutter bar assembly (not shown) and blade support portion 22 is replaced with blade support portion 1604 having a different shape. Foil shaver head 1600 connects to body 14 the same as trimmer head 12 so that drive shaft 50 of motor 17 extends through an opening of blade support portion 1604 so that extension 51 engages a slider (not shown) that is connected to the cutter bar assembly, for example, the slider has two parallel walls (not shown) that extend from the second side of the slider, so that rotation of drive shaft 50 of motor 17 moves extension 51 in the circular path around axis of rotation C that is translated into linear motion when extension 51 engages the slider of the cutter bar assembly, for example, extension 51 moves in the circular path between the two parallel walls that extend from the slider of the cutter bar assembly to alternately applying a force to each of the two parallel walls to generate a reciprocating motion of the cutter bar assembly that will cut hair that passes through holes of foil 1602.

Nose trimmer assembly 1700 is the same as trimmer head 12 except nose trimmer assembly 1700 replaces first blade 26 and second blade 28 with a nose trimmer blade assembly 1702 and blade support portion 22 is replaced with blade support portion 1704 having a different shape. Nose trimmer assembly 1700 connects to body 14 the same as trimmer head 12 except drive shaft 50 of motor 17 is positioned through an opening of blade support portion 1704 connecting extension 51 of drive shaft 50 to a blade 1706 of nose trimmer assembly 1700 so that rotation of extension 51 of drive shaft 50 rotates blade 1706 of nose trimmer assembly 1700.

Accordingly, hair trimmer 10 has a single handle, namely, body 14, that has at least three interchangeable attachments that include: 1) a reciprocating blade assembly as is typical in hair clippers and trimmers (trimmer head 12 and T-blade head 1500), 2) foil shaver head 1600, and 3) a nose trimmer head 1700 that are all are driven off of the same drive shaft 50 extending from the handle of body 14. Hair trimmer 10 advantageously provides functionality of a hair trimmer, a shaver and a nose trimmer so that users are not required to undesirably have multiple grooming appliances if they want, for example, trimming, nose trimming and/or shaving. Moreover, hair trimmer 10 reduces the space needed for appliances that accomplish nose trimming and/or shaving and only requires a single power source for all of trimmer head 12, T-blade head 1500, foil shaver head 1600, and a nose trimmer head 1700.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure should not be limited to the particular embodiment(s) disclosed as the best mode contemplated, but that the disclosure will include all embodiments falling within the scope of the appended claims.

What is claimed is:

1. A hair trimmer comprising:
a body housing a motor, the motor having a drive shaft that is rotatable and extends from the body; and
at least three interchangeable attachments that include a linearly reciprocating hair trimmer blade assembly, a foil shaver head and a rotary nose trimmer blade assembly, the linearly reciprocating hair trimmer blade assembly, the foil shaver head and the rotary nose trimmer blade assembly all being driven by the drive shaft when each of the linearly reciprocating hair trimmer blade assembly, the foil shaver head and the rotary nose trimmer blade assembly is connected to the body.

2. The hair trimmer of claim 1, wherein the body and each of the linearly reciprocating hair trimmer blade assembly, the foil shaver head and the rotary nose trimmer blade assembly are connectable by magnets.

3. The hair trimmer of claim 1, wherein the body has a spring latch that is actuated by a button.

4. The hair trimmer of claim 1, wherein the body forms a handle portion and a trimmer head connection portion that extends from the handle portion.

5. The hair trimmer of claim 4, wherein the trimmer head has a housing forming a body connection portion connectable to the body and a blade support portion that is connected to a first blade.

6. The hair trimmer of claim 5, wherein the first blade is in a fixed position on blade support portion and a second blade is movable.

7. The hair trimmer of claim 6, further comprising a protrusion of a slider that is connected to the second blade.

8. The hair trimmer of claim 7, wherein the protrusion extends from a first side of the slider and two parallel walls extend from a second side of the slider.

9. The hair trimmer of claim 8, wherein the second blade is connected to the protrusion on the first side of the slider.

10. The hair trimmer of claim 5, wherein the body has a first slot and a second slot on opposite sides of the trimmer head connection portion and a first magnet is connected to the trimmer head connection portion in the first slot and a second magnet is connected to the trimmer head connection portion in the second slot.

11. The hair trimmer of claim 3, wherein the spring latch has a protuberance that is connected to the button so that when the button is pressed, a portion of the protuberance is retracted inward inside of the body and when the button is released the protuberance returns to an extended position.

12. The hair trimmer of claim 1, wherein the drive shaft has an extension that is off center from an axis of rotation so that the extension moves in a circular path around the axis of rotation.

13. The hair trimmer of claim 5, wherein the blade support portion has an exterior surface that is opposite an interior surface so that the exterior surface connects to a first blade and an opening is formed through the exterior surface and the interior surface to receive the drive shaft to move a second blade.

14. The hair trimmer of claim 13, wherein the body connection portion has an outer wall that extends from the blade support portion and surrounds the interior surface and a third magnet is connected to an inner surface to protrude from the outer wall and a fourth magnet is connected to the inner surface to protrude from the outer wall.

15. The hair trimmer of claim 14, wherein the third magnet is positioned on the outer wall to be aligned with a first magnet of the body and the fourth magnet is positioned on the outer wall to be aligned with the second magnet of the body.

16. The hair trimmer of claim 1, wherein the linearly reciprocating hair trimmer blade assembly is a trimmer head.

17. The hair trimmer of claim 1, wherein the linearly reciprocating hair trimmer blade assembly is a T-blade head.

18. The hair trimmer of claim 1, wherein the linearly reciprocating hair trimmer blade assembly connects to the drive shaft to convert rotary motion of the drive shaft to linear motion.

19. The hair trimmer of claim 1, wherein the foil shaver head connects to the drive shaft to convert rotary motion of the drive to linear motion.

20. The hair trimmer of claim 1, wherein the rotary nose trimmer blade assembly connects to the drive shaft so that the drive shaft moves a blade of the rotary nose trimmer blade assembly by rotary motion of the drive shaft.
